(19) United States
(12) Patent Application Publication
(10) Pub. No.: US 2011/0299113 A1
(43) Pub. Date: Dec. 8, 2011

(54) IMAGE FORMING APPARATUS AND METHOD OF CONTROLLING SAME

(75) Inventor: Yoshiharu Ikegawa, Kawasaki-shi (JP)

(73) Assignee: CANON KABUSHIKI KAISHA, Tokyo (JP)

(21) Appl. No.: 13/112,449

(22) Filed: May 20, 2011

(30) Foreign Application Priority Data
Jun. 8, 2010 (JP) 2010-131506

(51) Int. Cl. G06F 3/12

(52) U.S. Cl. 358/1.15

(57) ABSTRACT

An image forming apparatus capable of communicating with an information processing apparatus receives identification information from the information processing apparatus, which has generated settings relating to a copy job to be executed in the image forming apparatus. The identification information indicates the settings of the copy job. The image forming apparatus displays multiple items of received identification information, notifies the information processing apparatus of identification information selected by a user, receives setting values of the copy job corresponding to the selected identification information, the setting values being transmitted from the information processing apparatus in response to the notification, determines whether the image forming apparatus is capable of executing the copy job based upon the setting values, and outputs the result of the determination.

### BACKGROUND OF THE INVENTION

1. Field of the Invention

The present invention relates to a technique whereby an image forming apparatus and an information processing apparatus cooperate to execute processing.

2. Description of the Related Art

In recent years, not only has cost competition become severe in the field of small-size image forming apparatuses, but further reductions in size and improved functionality are also in high demand. In order to provide maximum functionality and performance with limited hardware resources in these types of inexpensive image forming apparatus, there is a technique whereby an image forming apparatus and an external apparatus (such as a server or personal computer) cooperate to execute processing. This is a technique (an advanced copy function, for example) wherein the image forming apparatus and external apparatus cooperate to execute information processing or image processing, and implement an advanced function that cannot be provided only with the hardware resources of the image forming apparatus. For example, by using the technique described in Japanese Patent Laid-Open No. 8-186677, the construction of an image forming apparatus can be simplified and as a result, an inexpensive image forming apparatus can be provided.

An example of a technique that applies the teachings of Japanese Patent Laid-Open No. 8-186677 is as follows: According to the specification of Japanese Patent Laid-Open No. 8-186677, an image forming apparatus having a scanner and an external apparatus such as a personal computer are connected together in order to provide a copy function, and an image obtained by the image forming apparatus is subjected to image processing using the personal computer. By using the personal computer to execute the image processing for the copy function that used to be executed by the image forming apparatus, it is possible to make the image forming apparatuses with limited hardware resources. Further, according to Japanese Patent Laid-Open No. 8-186677, the personal computer operates the image forming apparatus (instructs the start of document reading and makes various settings).

On the other hand, an advanced copy function (a pseudo-copy function) that enables the above-mentioned copy function to be operated by a console unit on an image forming apparatus has been proposed. This is a function whereby an advanced copy function that cannot be implemented with the hardware resources of the image forming apparatus is achieved using the resources of an external apparatus such as a personal computer. This operation is also performed using the console unit of the image forming apparatus. A scan driver program and a print driver program are installed on the personal computer to control the document reading function of the image forming apparatus and the print function respectively. Upon receiving an advanced start copy command from the user, the image forming apparatus notifies the personal computer of this command. In response, the personal computer controls the reading and printing of documents performed by the image forming apparatus in accordance with each of the driver programs. Although the reading and printing of a document are performed by the image forming apparatus at this time, the image processing applied to the read image data is executed by the hardware and driver program of the personal computer. Even if the memory capacity of the image forming apparatus is small, this technique makes possible the layout processing and sorting processing of multiple pages by allowing image data to be stored on the hard-disk drive, etc., of the personal computer instead of the image forming apparatus. Furthermore, it is possible to improve performance while lowering the cost of the image forming apparatus by only providing images processed by the minimum necessary hardware, and executing complicated and advanced image processing as well as color conversions in an image processing program that has been installed in the personal computer.

A problem which arises in such cooperative processing is that if there is a mismatch between the status of the image forming apparatus and the advanced copy settings, there is a delay before the mismatch becomes evident. Conceivable examples are when the paper size to which the image forming apparatus has been set differs from the paper size set by advanced copy, and when paper of the size set by advanced copy does not exist in the image forming apparatus. Since this problem first becomes evident when the image forming apparatus receives the advanced-copy print job from the personal computer, the result is a decline in user friendliness. It might even happen that advanced copy cannot be performed in the event that no document has been placed in the automatic document feeder despite the fact that the automatic document feeder has been set by the advanced copy to read a document.

### SUMMARY OF THE INVENTION

An aspect of the present invention is to eliminate the above-mentioned problems that exist in the conventional technology.

A characterizing feature of the present invention is to quickly determine whether or not cooperative processing can be executed by cooperation between an image forming apparatus and an information processing apparatus and notify a user of the determined result.

According to an aspect of the present invention, there is provided an image forming apparatus capable of communicating with an information processing apparatus, comprising: a first receiving unit configured to receive identification information from the information processing apparatus, which has generated settings relating to a copy job to be executed in the image forming apparatus, the identification information indicating the settings of the copy job; a first display unit configured to display multiple items of identification information received by the first receiving unit; a notification unit configured to notify the information processing apparatus of identification information selected by a user from among the multiple items of identification information displayed by the first display unit; a second receiving unit configured to receive setting values of the copy job corresponding to the selected identification information, the setting values being transmitted from the information processing apparatus in response to the notification made by the notification unit; a determination unit configured to determine whether or not the image forming apparatus is capable of executing the copy job based upon the setting values received by the second receiving unit; and an output unit configured to output a result of the determination made by the determination unit.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating the overall configuration of an image forming apparatus according to an embodiment of the present invention;

FIG. 2 is a functional block illustrating the functional configuration of a control unit according to the embodiment;

FIG. 3 is a diagram showing the appearance of a console unit on the image forming apparatus according to the embodiment;

FIGS. 4A to 4D are diagrams useful in describing examples of displays on a display unit of the image forming apparatus in a case where a copy function and an advanced copy function have been selected;

FIGS. 5A to 5E are diagrams useful in describing examples of user interface screens by which the user of a personal computer sets the details of advanced copy according to this embodiment;

FIG. 6 is a diagram useful in describing an example of an advanced copy sequence according to this embodiment;

FIG. 7 is a flowchart describing document-read processing in a case where advanced copy has been specified in an image forming apparatus according to a first embodiment;

FIG. 8 is a flowchart describing print processing executed by an image forming apparatus according to the first embodiment; and

FIG. 9 is a flowchart describing document-read processing in a case where advanced copy has been specified in an image forming apparatus according to a second embodiment.

### DESCRIPTION OF THE EMBODIMENTS

Embodiments of the present invention will be described hereinafter in detail with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

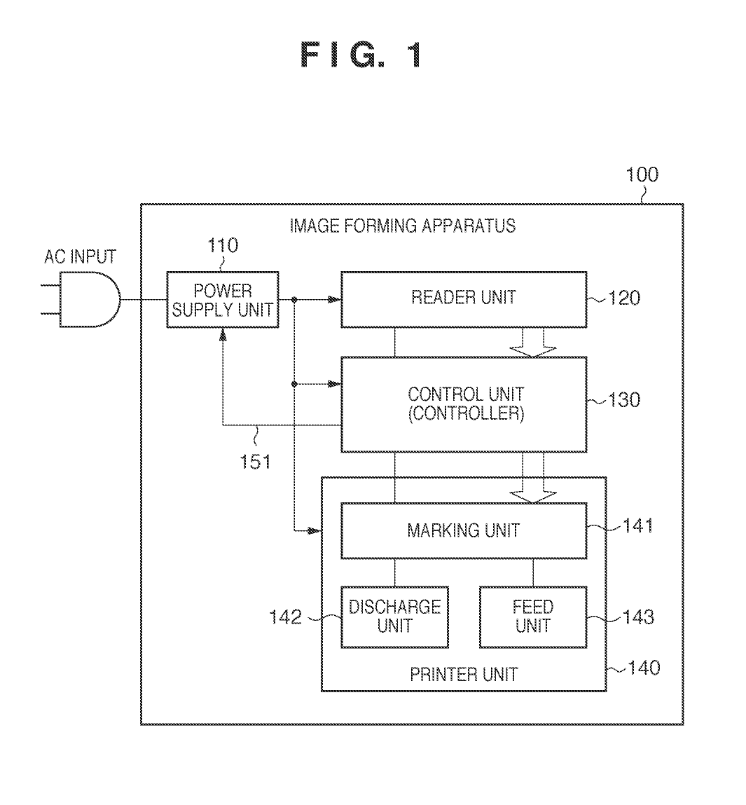

FIG. 1 is a block diagram illustrating the overall configuration of an image forming apparatus 100 according to an embodiment of the present invention.

A reader unit (image input unit) 120 reads an image of a document optically and converts the image to image data. The reader unit 120 is equipped with a scanner unit (not shown) used for reading documents, and a document feed unit (not shown) used for feeding documents.

A printer unit (image output unit) 140 transports a sheet of printing paper, forms (prints) a visible image of the image data on the sheet and then ejects the sheet to the exterior of the apparatus. The printer unit 140 includes a feed unit 143 having a plurality of paper cassettes containing sheets of paper of a plurality of types, a marking unit 141 for printing an image based upon image data, and a discharge unit 142 for sorting printing sheets, stapling the sheets together and then ejecting them.

A control unit (controller) 130 is electrically connected to the reader unit 120 and printer unit 140. The control unit 130 provides a copy function for reading a document and generating image data by controlling the reader unit 120 and for printing an image on a sheet by controlling the printer unit 140 based upon the image data. The control unit 130 further has a scanner function for converting the image data, which has entered from the reader unit 120, to code data and transmitting the code data to the personal computer via a network. The control unit 130 further provides a printer function for converting code data, which has been received from the personal computer via the network, to image data and printing the image by the printer unit 140 based upon the image data.

A power supply unit 110 receives an input of AC power and generates voltage for supplying the control unit 130, reader unit 120 and printer unit 140 with a DC or AC voltage. The power supply unit 110 is capable of controlling the generated DC voltage in accordance with a control signal 151 from the control unit 130.

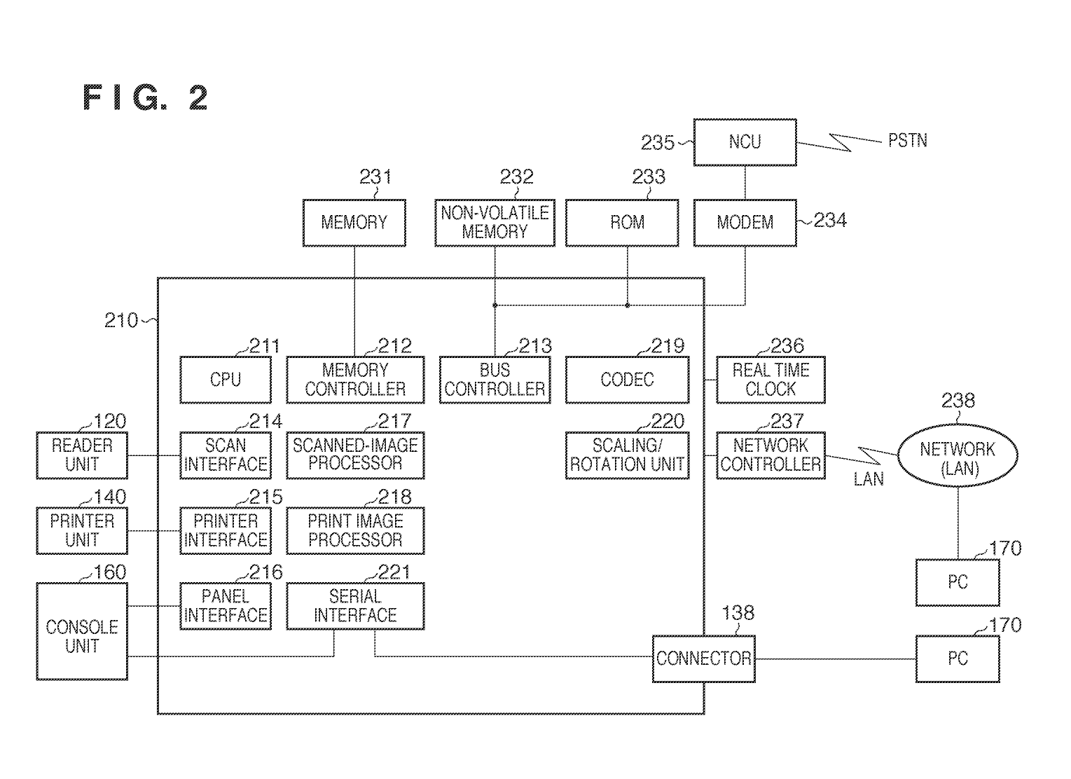

FIG. 2 is a functional block illustrating the functional configuration of the control unit 130 according to the embodiment. Components in FIG. 2 identical with those shown in FIG. 1 are designated by like reference characters.

A main controller 210 mainly includes a CPU 211, a memory controller 212, a bus controller 213, a scan interface 214, a printer interface 215 and a panel interface 216. The main controller 210 further includes a scanned-image processor 217, a print image processor 218, a codec 219, a scaling/rotation unit 220 and a serial interface 221. The details will be described below.

The main controller 210 and memory controller 212 control the overall operation of the control unit 130, and the CPU 211 operates based upon a program stored in a memory 231. Processing for interpreting PDL (Page Description Language) data received from a personal computer 170 and expanding the interpreted data into raster image data also is described in this program. As a result, processing for interpreting code data and expanding raster image data is executed by the CPU 211. The memory controller 212, which controls transfer of data input and output to and from each of the interfaces, controls arbitration at the time of bus conflict as well as data transfer by DMA. The bus controller 213 controls access to a non-volatile memory 232, a ROM 233 and a modem 234.

The scan interface 214 receives image data that enters from the reader unit 120 and transfers this image data to the memory 231 and scanned-image processor 217. The scanned-image processor 217 has a function for applying prescribed image processing to image data received from the scan interface 214. Examples of this image processing include a line-pitch correction, offset correction, non-linear correction, color space matching, MTF correction, spatial filtering, achromatic discrimination and the like.

The printer interface 215 produces a control signal based upon a video control signal sent from the printer unit 140 and outputs a video signal to the printer unit 140 in conformity with this control signal. Raster image data from the memory 231 is input to the print image processor 218, which functions to output data, which has undergone halftone image processing, to the memory 231. Examples of image processing in this case are color space compression, undercolor removal, log conversion, non-linear color space conversion, random-number addition, gamma conversion, error diffusion processing, screen processing and the like.

The codec 219 compresses raster image data using a scheme such as MH/MR/MMR/JBIG/JPEG. Conversely, the codec 219 expands compressed and stored code data to raster image data and stores the expanded data in the memory 231. The scaling/rotation unit 220 has functions for executing processing to enlarge or reduce the size of the image represented by the raster image data that has been stored in the memory 231, and rotation processing for rotating the image 90°, 180° and 270°. The non-volatile memory 232 stores the programs of the CPU 211 as well as various settings data. The ROM 233 is used to store the user mode and various settings information. The ROM 233 also contains a font ROM and the like for storing font information such as characters.

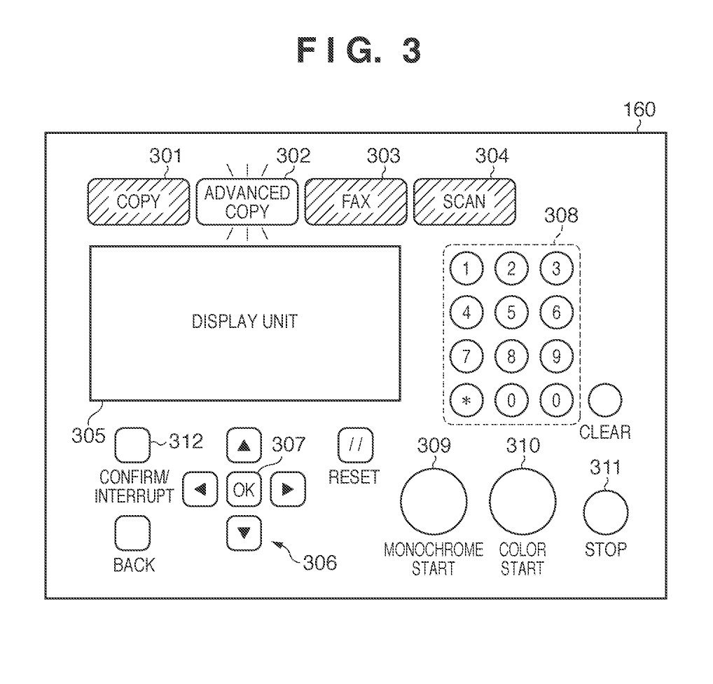

The panel interface 216 communicates with a console unit 160. The console unit 160 has a display unit 305 (see FIG. 3) such as a liquid crystal display and a plurality of hard keys (see FIG. 3). A signal that has been input from the hard keys is sent to the CPU 211 via the above-mentioned panel interface 216. The display unit 305 displays the data sent from the panel interface 216. The display unit 305 displays the functions, etc., relating to the operation of the image forming apparatus. The serial interface 221 communicates with the personal computer 170 and various devices via a connector 138. A USB can be mentioned as an example of a serial bus. The serial interface 221 is used as an interface for receiving PDL data from the personal computer 170 when transmitting commands and transferring image data to a recording medium on which digital image data has been recorded.

The modem 234 and an NCU 235 are connected to a public line (PSTN) and control facsimile communication. A real-time clock module 236, which updates and stores the date and time managed by the image forming apparatus 100, is backed up by a back-up battery. A network controller 237 is connected to a network 238. Ethernet can be mentioned as an example of the network 238, which is used to receive PDL data from the personal computer, transmit image data read by the reader unit 120 and perform remote management and the like.

FIG. 3 is a diagram showing the appearance of the console unit 160 on image forming apparatus 100 according to this embodiment.

The console unit 160 has function keys 301 to 304 for selecting functions. By pressing the key of a function desired to be used, the user can instruct execution of this function. The function keys include a copy key 301, an advanced copy key 302, a FAX key 303 and a scan key 304. FIG. 3 illustrates the state that results when the advanced copy function has been designated by pressing the advanced copy key 302. Further, the display unit 305 is used to notify the user of various set states and of the device status of the image forming apparatus 100. Arrow keys 306 have four buttons, namely up, down, left, right buttons, and are used to move a cursor or the like displayed on the display unit 305. Placed at the center of the arrow keys 306 is an OK key 307. This key has the function of an “ENTER” key for finalizing various settings and inquiries. For example, if it is desired to change a copy setting (paper size), the user presses the copy key 301 to establish the copy function screen, uses the arrow keys 306 to select the item (paper size) desired to be changed and then presses the OK key 307, whereby the screen transitions to a setting screen that makes it possible to select the paper size. The user then uses the arrow keys 306 to move the cursor to the position of the desired paper size and presses the OK key 307, thereby enabling the copy function that uses the paper of the designated size. A numeric keypad 308 is used to enter a numerical value such as the number of copies or a telephone number associated with the facsimile function. Other keys are a monochrome start key 309 and a color start key 310 serving as keys for instructing start of copy, scan and facsimile. A function for reading in a document in monochrome mode and a function for copying a document in monochrome mode are implemented when the monochrome start key 309 is pressed, and a function for reading in a document in color mode and a function for copying a document in color mode are implemented when the color start key 310 is pressed. A stop key 311 is for halting the operation of each function. In a case where an operation is halted, the user uses a confirm/interrupt key 312 to display a status confirmation screen for the purpose of confirming the status of process currently being executed by the image forming apparatus 100, or to select the process desired to be halted, thereby halting this processing. In this case also the arrow keys 306 and OK key 307 are used in selecting an item and in finalizing the selection.

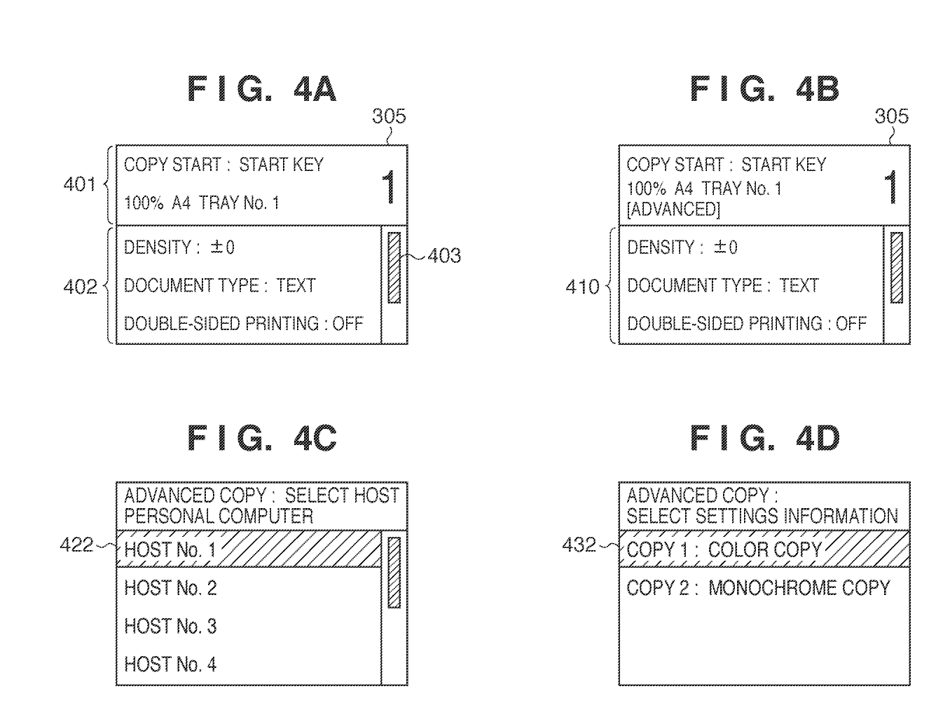

The display presented on the display unit 305 of console unit 160 of image forming apparatus 100 according to this embodiment will be described with reference to FIGS. 4A to 4D.

FIGS. 4A to 4D are diagrams useful in describing examples of displays on the display unit 305 in a case where the copy function and advanced copy function have been selected. The screen displayed on the display unit 305 will be referred to as a UI (user interface) screen below.

FIG. 4A is a diagram illustrating an example of the UI screen displayed when the copy key 301 among the function keys of FIG. 3 has been pressed. A status display 401 displays typical settings and status information associated with the copy function. This display indicates a case where the following holds when a “normal copy function” is in effect: “non-scaling (100%), paper size “A4” and the fact that a sheet of paper will be fed from a Tray No. 1. A setting item 402 displays various setting items in list form. The cursor is moved by the up and down keys of the arrow keys 306 and an item is selected by the OK key 307. Since the setting item 402 includes items other than the three items that are being displayed, pressing the down key among the arrow keys 306 will bring these items into view from below one after another. A scroll bar 403 indicates the cursor position. Here density has been set to “±0”, document type to “TEXT” and double-sided printing to “OFF”.

FIG. 4B is a diagram illustrating an example of the UI screen displayed when the advanced copy key 302 among the function keys of FIG. 3 have been pressed. In order to distinguish this display from the status display 401 of the ordinary copy function in FIG. 4A, “ADVANCED”, which indicates that this is the UI screen of the advanced copy function, is being displayed following “TRAY No. 1”. A setting item 410 is the same as that of the ordinary copy function of FIG. 4A. Setting items capable of being implemented by advanced copy are added on, as illustrated in FIGS. 4C and 4D.

The advanced copy function implements a copy function by cooperation between the image forming apparatus 100 and the personal computer 170 capable of communicating with the image forming apparatus 100. It is necessary, therefore, to select the personal computer that will cooperate. FIG. 4C illustrates an example of setting items added in order to select the personal computer that will operate in concert with the image forming apparatus. The section in which the background is reversed to black and the characters are reversed to white indicates the position of the cursor, as shown at 422. This cursor position can be moved by the up and down keys of the arrow keys 306, and the personal computer that has been designated by the cursor can be selected by the OK key 307 as the personal computer that is to execute advanced copy cooperatively. In FIG. 4C, “HOST No. 1” has been designated as the personal computer that is to operate in concert with the image forming apparatus 100.

A case where the advanced copy application of the personal computer 170 is made to select the setting information is conceivable as another form of the advanced copy function. Specifically, the user uses the personal computer 170 to preset several (more than one) types of advanced copy setting. It can be so arranged that when the advanced copy function is designated by the image forming apparatus 100 and this function is executed, it will suffice to merely select the setting of the advanced copy function that has been set beforehand by this personal computer 170. An example of the setting items added on in this case is illustrated in FIG. 4D. In the example of FIG. 4D, “COLOR COPY”, which has been preset in the personal computer 170, has been selected by the cursor, as indicated at 432. Examples of items set by the personal computer 170 besides the foregoing are whether the document type is color or monochrome, the size of the document, the size (magnification) of the paper to be printed on, the layout, the resolution and the like. Although these are the setting items mentioned in this embodiment, other setting items relating to copying may exist as well.

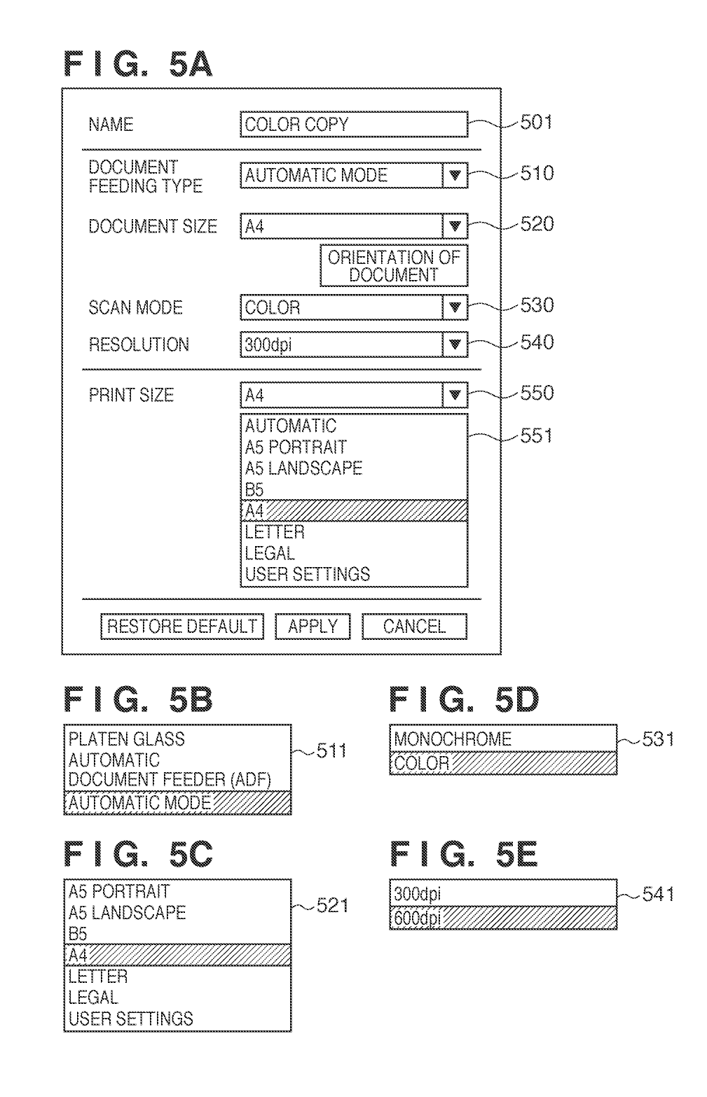

FIGS. 5A to 5E are diagrams useful in describing examples of user interface screens by which the user of a personal computer sets the details of advanced copy according to this embodiment.

FIG. 5A illustrates an example of a user interface screen displayed when the user sets the details of the advanced copy function using the personal computer 170.

NAME 501 indicates the set name of advanced copy. This agrees with the name (here “COLOR COPY”) of advanced copy selected in FIG. 4D. DOCUMENT FEEDING TYPE 510 designates the method of reading the document that is to be scanned. The method is chosen from a dialog box 511 in FIG. 5B by selecting from a drop-down list button. The candidates for selection are “PLATEN GLASS” (read a document that has been placed on the platen glass), “AUTOMATIC DOCUMENT FEEDER” and “AUTOMATIC MODE”, in which these candidates are selected automatically. “AUTOMATIC MODE” has been selected in FIG. 5B.

“DOCUMENT SIZE” 520 designates the size of the document to be scanned. The document size is chosen from a dialog box 521 in FIG. 5C by selecting from a drop-down list button. A list of paper sizes that can be read is included as the candidates. Size “A4” has been selected in FIG. 5C. “SCAN MODE” 530 designates the document reading mode. A selection is made from a dialog box 531 in FIG. 5D by selecting from a drop-down list button. “MONOCHROME” and “COLOR” are included as the candidates in FIG. 5D, and “COLOR” has been selected. “RESOLUTION” 540 designates the resolution at which the document is read. A selection is made from a dialog box 541 in FIG. 5E by selecting from a drop-down list button. Here “300 dpi” and “600 dpi” are included as the candidates, and “600 dpi” has been selected in FIG. 5E. “PRINT SIZE” 550 designates the side of paper to be printed on. A selection is made from a dialog box 551 by selecting from a drop-down list button. Included as the candidates are a list of paper sizes printable by the image forming apparatus 100, and “AUTOMATIC”, which selects the paper size designated based upon the paper that has been placed in the image forming apparatus 100 or by the document size 520. In FIG. 5A, “A4” size is selected as a print size 550.

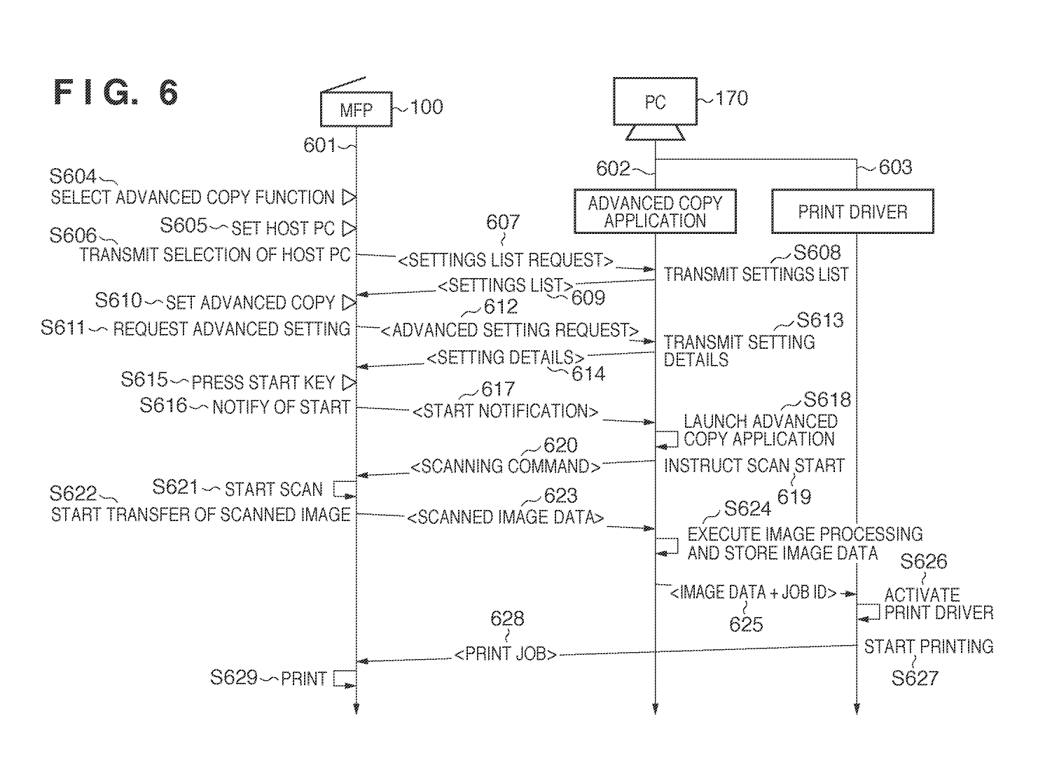

FIG. 6 is a diagram useful in describing an example of the flow of advanced copy processing according to this embodiment.

Advanced copy refers to copy processing in which the image forming apparatus 100 and the personal computer 170 capable of communicating with the image forming apparatus 100 execute processing by cooperating. Specifically, a copy function that cannot be implemented with the hardware sources of the image forming apparatus 100 is implemented by cooperation between both the image forming apparatus 100 and personal computer 170, which is an information processing apparatus, by using the hardware sources of the personal computer 170 (inclusive of the control program stored in these hardware resources).

A time axis 601 shown on the left side of FIG. 6 represents a sequence of operations executed by the image forming apparatus 100, and two time axes 602 and 603 shown on the right side represent sequences of operations performed by the application and print driver, respectively, of the personal computer 170. In the description of FIG. 6, it will be assumed that an advanced copy application and print driver conforming to the image forming apparatus 100 have been installed in the personal computer 170 beforehand.

First, in step S604, it is assumed that the user has selected the advanced copy function (pressed the advanced copy key 302 on the console unit 160) at the image forming apparatus 100. The image forming apparatus 100 responds by causing the display unit 305 to display the screen (FIG. 4C) of the list of personal computers for the purpose of selecting the personal computer that is capable of operating in concert with the image forming apparatus 100. In accordance with the display, the user selects the personal computer that will cooperate [here it will be assumed that this is personal computer 170 (HOST No. 1)] in step S605. In response, in step S606, the image forming apparatus 100 sends the selected personal computer 170 a setting list request command 607, which requests the selected personal computer 170 for a list of settings made beforehand using this personal computer. FIG. 5A illustrates an example of a display of items that have been set by “COLOR COPY” in this list of settings. As a result, the personal computer 170 responds to this command in step S608 by transmitting a settings list 609 to the image forming apparatus 100. Based upon the settings list 609 received, the image forming apparatus 100 displays the selection screen, which is shown in FIG. 4D, on the display unit 305. In accordance with this settings list, the user of the image forming apparatus 100 selects the setting of advanced copy in step S610, whereupon the image forming apparatus 100 issues an advanced setting request command 612 to the personal computer 170 in step S611. In response to the advanced setting request command 612, the personal computer 170 transmits setting details (the content of the settings of FIG. 5A, for example) 614, described later, to the image forming apparatus 100 in step S613. As a result, the image forming apparatus 100 displays the setting details on the display unit 305. Thus, the user of the image forming apparatus 100 is capable of confirming the function settings of advanced copy set by the personal computer 170 beforehand.

Next, the image forming apparatus 100 waits for the user to press the start key on the console unit 160. When the user presses the color start key 310 in step S615, the image forming apparatus 100 transmits a start command 617 to the personal computer 170 in step S616. Upon receiving the start command 617, the personal computer 170 launches the advanced copy application in step S618 and transmits a scanning command 620, which instructs the image forming apparatus 100 to start reading a document, to the image forming apparatus 100 in step S619. As a result, in accordance with the scanning command 620, the image forming apparatus 100 reads the document using the reader unit 120 in step S621. In order to simplify the description in connection with FIG. 6, a case where advanced copy of a single document is executed will be described.

In step S622, the image forming apparatus 100 transmits the image data, which has been obtained by reading the document, to the personal computer 170 as scanned image data 623 as is (in the form of RAW data) or after being subjected to image processing capable of being implemented using the hardware resources of the image forming apparatus 100. As a result, in step S624, the personal computer 170 applies the prescribed image processing to the transmitted image data, encodes the data as necessary and stores the image data in a storage device (not shown). In the case of a plurality of documents, similar image processing is applied repeatedly to image data that continues to be transmitted and, until reception of all of the image data ends, the received image data is stored in the storage device of the PC 170. If the transfer of all of the scanned image data thus ends, the image forming apparatus 100 transitions to the standby state.

Next, the advanced copy application of the personal computer 170 reads out the image data that has been stored on the storage device (hard-disk drive) of the personal computer 170, and executes processing using the print driver that has been installed in the personal computer 170. That is, the advanced copy application of the personal computer 170 supplies the print driver with data 625 obtained by appending a job ID to this image data. As a result, the print driver is activated in step S626 and, while the image data received from the advanced copy application is stored (spooled), the print driver transmits a print job 628 to the image forming apparatus 100 in step S627. As a result, the image forming apparatus 100, set to function in the advanced copy mode, performs printing in accordance with the received print data in step S629.

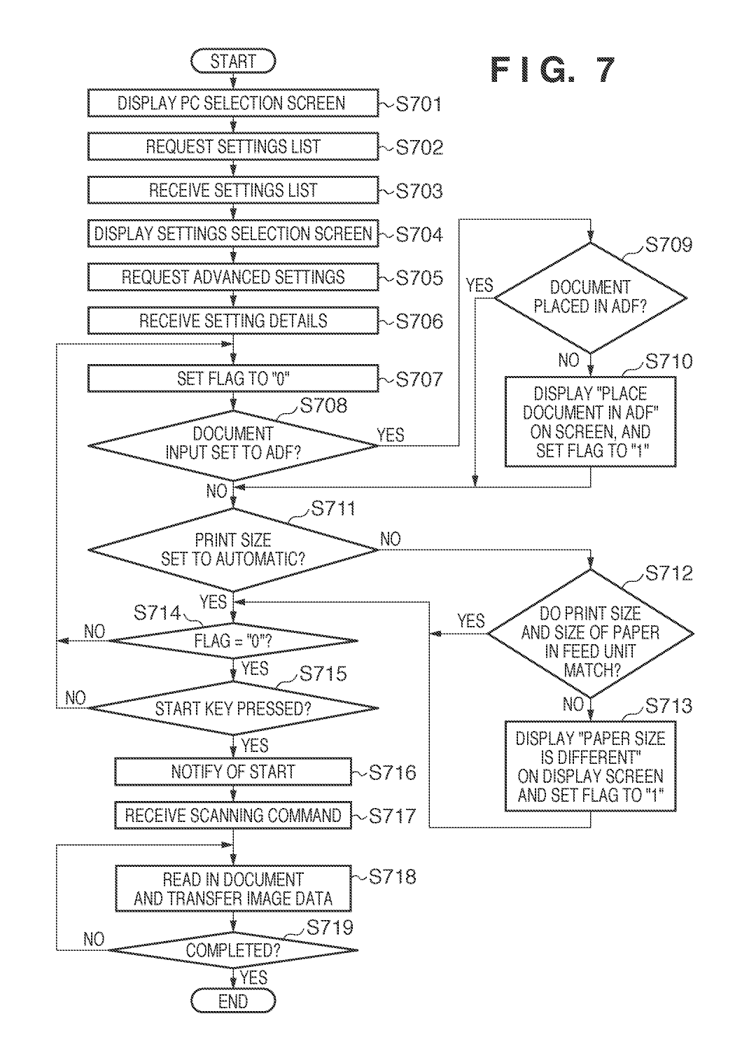

FIG. 7 is a flowchart describing document-read processing in a case where advanced copy has been specified in the image forming apparatus 100 according to a first embodiment. It should be noted that this processing is achieved by having the CPU 211 expand the program, which has been stored in the non-volatile memory 232, in the memory 231 and execute processing in accordance with this program. It will be assumed here that the advanced copy function has been selected by pressing the advanced copy key 302 on the console unit 160. This processing will be described with reference to both FIGS. 6 and 7.

First, in step S701, the image forming apparatus 100 displays the selection screen (FIG. 4C), which is the display of the list of personal computers for selecting the personal computer that is to execute processing cooperatively, and waits for the user to select the personal computer. When the user selects a personal computer on this screen, control proceeds to step S702. Here the image forming apparatus 100 sends the selected personal computer 170 the setting list request command 607 requesting the list of settings made using this personal computer with regards to copy processing. Then, in step S703, the image forming apparatus 100 waits until the settings list 609 is received from the personal computer 170. When the settings list 609 is received from the personal computer 170 in step S703, control proceeds to step S704. Here the image forming apparatus 100 displays the settings selection screen (FIG. 4D) for advanced copy and waits for the user to select the settings information. When the user selects the settings information, control proceeds to step S705 and the image forming apparatus 100 issues the advanced setting request command 612 to the personal computer 170. Then, in step S706, the image forming apparatus 100 waits until the setting details 614 is received from the personal computer 170. A list having the content shown in FIG. 5A is an example of the setting details 614. When the setting details 614 are thus received from the personal computer 170 in step S706, control proceeds to step S707, where the image forming apparatus 100 sets a start determination flag to “0”. The start determination flag is set in the memory 231.

Next, control proceeds to step S708. Here the image forming apparatus 100 confirms DOCUMENT FEEDING TYPE 510 indicated in FIG. 5A and the size of the document that has been placed in the reader unit 120, these being contained in the setting details 614 received from the personal computer 170. Here it is determined whether the setting of DOCUMENT FEEDING TYPE 510 has been set to the automatic document feeder (ADF below). Control then proceeds to step S711 if the ADF has not been thus set. If DOCUMENT FEEDING TYPE 510 has been set to ADF, control proceeds to step S709 and it is determined whether a document has been placed in the ADF. If it is found in step S709 that a document has been set in the ADF, control proceeds to step S711. Otherwise, control proceeds to step S710 and a warning message is displayed on the display unit 305 of console unit 160. For example, a message such as “PLACE DOCUMENT IN ADF” is displayed, the start determination flag is set to “1” and control proceeds to step S711.

In step S711, the image forming apparatus 100 determines whether the print size that has been set in PRINT SIZE 550 (FIG. 5A) of the setting details 614 is “AUTOMATIC” and proceeds to step S714 if the print size has been set to automatic. On the other hand, if it is found in step S711 that the print size that has been set in PRINT SIZE 550 of the setting details 614 is not “AUTOMATIC”, then control proceeds to step S712. Here the image forming apparatus 100 compares the print size and the size of the paper that has been placed in the feed unit 143 and determines whether or not they match. If the print size and the size of the paper that has been placed in the feed unit 143 do not match, or if there is no paper in the feed unit 143, control proceeds to step S713. A warning message is displayed on the display unit 305 of the console unit 160, the start determination flag is set to “1” and control proceeds to step S714. If the paper size does not match, a message such as “PAPER SIZE IS DIFFERENT” is displayed as an example of the warning message. If there is no paper, a message such as “OUT OF PAPER” is displayed. When it is found in step S712 that the print size matches the size of the paper that has been placed in the feed unit 143, control proceeds to step S714.

It is determined in step S714 whether the start determination flag is “0”. If the flag is not “0” (“1” indicates a mismatch), control returns to step S707 and the image forming apparatus 100 executes the above-described processing. Accordingly, a command to start advanced copy processing cannot be input as long as this mismatch is not eliminated. That is, start of advanced copy processing is inhibited.

On the other hand, if the start determination flag is “0”, that is, if a document to be read has been placed in the ADF and paper having a size conforming to the side of this document has been placed in the image forming apparatus 100, control proceeds to step S715 and the image forming apparatus 100 waits for the operator to press the color start key 310 on the console unit 160. If it is found in step S715 that the color start key 310 has not been pressed, control returns to step S707 and the determination operation is repeated until the color start key 310 is pressed. Thus, when the color start key 310 is pressed, control proceeds to step S716 and the image forming apparatus 100 transmits the start command 617 to the personal computer 170. When it is found in step S711 that the print size is “AUTOMATIC”, a list of the paper size settings set in the image forming apparatus 100 is transmitted together with the start command 617 to the personal computer 170. Control then proceeds to step S717, where the image forming apparatus 100 waits for the scanning command 620 to be sent from the personal computer 170.

If the scanning command 620 is received from the personal computer 170 in step S717, control proceeds to step S718. Here the image forming apparatus 100 starts the reading of the document by the reader unit 120 and transmits the image data thus obtained to the personal computer 170 as the scanned image data 623. As a result, the personal computer 170 receives this image data, stores this image data and subjects it to image processing. In step S719, the image forming apparatus 100 determines whether reading of all documents has been completed. If such reading has not been completed, control returns to step S718 and the image forming apparatus 100 repeats processing repeatedly.

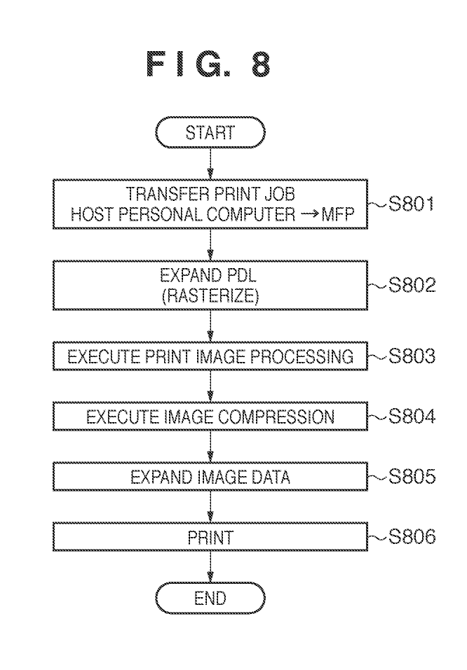

FIG. 8 is a flowchart describing print processing executed by the image forming apparatus according to the first embodiment. The flowchart of FIG. 8 comprises of steps S801 to S806. It should be noted that this processing is achieved by having the CPU 211 expand the program, which has been stored in the non-volatile memory 232, in memory 231 and execute processing in accordance with this program. This processing corresponds to a case where the personal computer 170 processes the image and transmits the resulting image data as a print job after the read image data is transmitted to the personal computer 170 from the image forming apparatus 100 in the flowchart in FIG. 7.

When a print job is executed and printing performed, first the image forming apparatus 100 receives the print job 628 (FIG. 6) along with print settings parameter information from the personal computer 170 via the network 238 or connector 138 in step S801. Next, control proceeds to step S802, where the image forming apparatus 100 rasterizes the print job into image data based upon the print settings parameters and stores the rasterized image data in the memory 231. Next, control proceeds to step S803, where the image forming apparatus 100 inputs the rasterized image data rendered in step S802 to the print image processor 218 in a point-sequential fashion, subjects the image data to image processing and then halftone processing and stores the result in the memory 231 as halftone image data. Next, control proceeds to step S804, where the image forming apparatus 100 compresses the halftone image data using the codec 219 and stores the compressed data in memory 231 temporarily. Next, control proceeds to step S805, where the image forming apparatus 100 expands the stored compressed image data using the codec 219 and stores the result in the memory 231 as halftone image data. Control then proceeds to step S806, where the image forming apparatus 100 synchronizes the halftone image data expanded in step S805 to a control signal from the marking unit 141 and outputs the data to the printer unit 140 via the printer interface 215. The image represented by the image data is printed by the printer unit 140. When the printing of the image represented by the image data is thus completed, that is, when the print job ends, the image forming apparatus 100 ends the print processing.

Thus, the first embodiment as described above is such that if advanced copy is specified, a mismatch between the state to which the image forming apparatus 100 has been set and the setting details 614 of the advanced copy function set by the personal computer 170 is discriminated before the start key of the image forming apparatus 100 is pressed. If a mismatch is discovered, the console unit 160 of the image forming apparatus 100 displays a message alerting the user so that the user will eliminate the mismatch. If the mismatch is not eliminated, a start command cannot be input from the image forming apparatus 100. As a result, in a case where a function in which an image forming apparatus and a personal computer operate in concert is executed, as in advanced copy, the function cannot be started if there is a discrepancy in the settings for implementing this function between the image forming apparatus and the personal computer. This means that it is possible to eliminate the problem described earlier, namely a delay in clarification of a mismatch in the event that a mismatch occurs between the status of the image forming apparatus and the settings of the cooperative function.

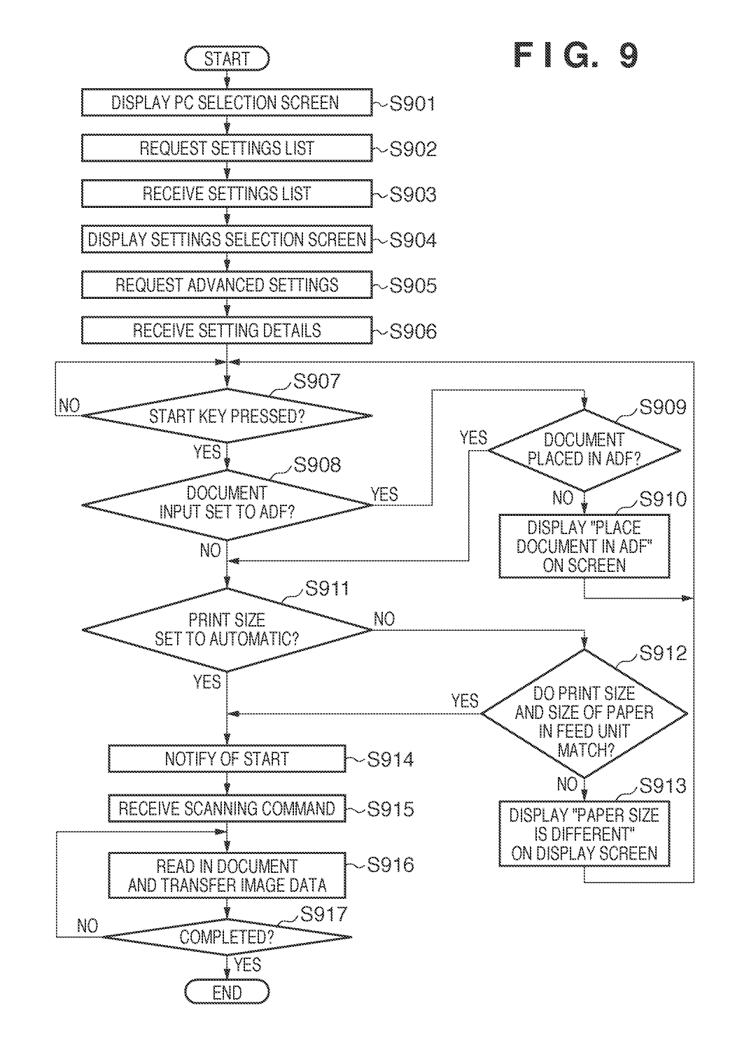

It does not matter if a mismatch between the settings of the image forming apparatus and the settings of the cooperative function is discriminated after the start key on the image forming apparatus is pressed. Such a configuration constitutes a second embodiment of the present invention. The operation of the image forming apparatus 100 in this case will be described with reference to the flowchart in FIG. 9.

FIG. 9 is a flowchart describing document-read processing in a case where advanced copy has been specified in an image forming apparatus according to a second embodiment. In this case also, in a manner similar to that in FIG. 3 of the first embodiment, it is assumed that the user has selected the advanced copy function by pressing the advanced copy key 302 on the console unit 160 at the image forming apparatus 100. This processing is achieved by having the CPU 211 expand the program, which has been stored in the non-volatile memory 232, in the memory 231 and execute processing in accordance with this program. Since the configuration of the image forming apparatus 100 and the processing executed by the personal computer 170 are similar to those of the first embodiment, they need not be described again. Steps S901 to S906 in FIG. 9 are the same as steps S701 to S706 of FIG. 7, and steps S908 to S913 in FIG. 9 are the same as steps S708 to S713 of FIG. 7.

First, in step S901, the image forming apparatus 100 displays the selection screen in FIG. 4C for selecting a personal computer and waits for the user to select a personal computer. When the user selects a personal computer, control proceeds to step S902 and the image forming apparatus 100 sends the selected personal computer (here the personal computer 170) the setting list request command 607. Then, in step S903, the image forming apparatus 100 waits until the settings list 609 is received from the personal computer 170. When the settings list 609 is received from the personal computer 170 in step S903, control proceeds to step S904. Here the image forming apparatus 100 displays the settings selection screen (FIG. 4D) for advanced copy on the display unit 305 and waits for the user to make a selection. When the user selects the settings, control proceeds to step S905 and the image forming apparatus 100 transmits the advanced setting request command 612 to the personal computer 170. Then, in step S906, the image forming apparatus 100 waits until the setting details 614 is transmitted from the personal computer 170. A list having the content shown in FIG. 5A is an example of the setting details 614. When the setting details 614 are received in step S906, control proceeds to step S907 and the image forming apparatus 100 waits for the user to press the color start key 310 on the console unit 160.

If it is found in step S907 that the color start key 310 has been pressed, control proceeds to step S908, where the image forming apparatus 100 confirms the document setting of DOCUMENT FEEDING TYPE 510 in FIG. 5A. It is determined whether the setting of DOCUMENT FEEDING TYPE 510 has been set to ADF. Control proceeds to step S911 if the ADF has not been thus set. If DOCUMENT FEEDING TYPE 510 of the setting details 614 has been set to ADF, control proceeds to step S909 and it is determined whether a document has been placed in the ADF. If it is found in step S909 that a document has been set in the ADF, control proceeds to step S911. Otherwise, control proceeds to step S910. Here a warning message, “PLACE DOCUMENT IN ADF”, for example, is displayed on the display unit 305 of console unit 160. Control then proceeds to step S907.

In step S911, the image forming apparatus 100 determines whether or not the print size that has been set in PRINT SIZE 550 (FIG. 5) of the setting details 614 is “AUTOMATIC”, and proceeds to step S914 if the print size has been set to “AUTOMATIC”. On the other hand, if it is found at step S911 that the print size that has been set in PRINT SIZE 550 of the setting details 614 is not “AUTOMATIC”, then control proceeds to step S912. Here the image forming apparatus 100 determines whether the print size and the size of the paper that has been placed in the feed unit 143 match. If the print size and the size of the paper that has been placed in the feed unit 143 do not match, or if there is no paper in the feed unit 143, control proceeds to step S913. A warning message is displayed on the display unit 305 of the console unit 160 and control proceeds to step S907. Examples of the warning message are “PAPER SIZE IS DIFFERENT” if the paper size does not match and “OUT OF PAPER” if there is no paper. If it is found in step S912 that the print size matches the size of the paper that has been placed in the feed unit 143, control proceeds to step S914.

In step S914, the image forming apparatus 100 transmits the start command 617 to the personal computer 170 since a document has been placed in the image forming apparatus 100 and the size of the document matches the size of the paper in the paper feed unit. Next, control then proceeds to step S915, where the image forming apparatus 100 waits for the scanning command 620 from the personal computer 170. If it has been found in step S911 that the print size is “AUTOMATIC”, the list of paper size settings in the image forming apparatus 100 is transmitted along with the start command 617 to the personal computer 170. If the scanning command 620 is received from the personal computer 170 in step S915, control proceeds to step S916. Here the image forming apparatus 100 starts the reading of the document by the reader unit 120 and transmits the image data thus obtained to the personal computer 170 as the scanned image data 623. In step S917, the image forming apparatus 100 determines whether reading of all documents has been completed. If such reading has not been completed, the processing of step S916 is executed repeatedly.

Processing for receiving and printing (copying) image data, which has undergone image processing, from the personal computer 170 is subsequently executed according to the flowchart shown in FIG. 8.

Thus, the second embodiment as described above is such that if advanced copy is specified, a mismatch between the state to which the image forming apparatus 100 has been set and the setting details 614 of the advanced copy function set by the personal computer 170 is discriminated after the start key of the image forming apparatus 100 is pressed. If a mismatch is discovered, the console unit 160 of the image forming apparatus 100 displays a message instructing the user to eliminate the mismatch. If the mismatch is not eliminated, the personal computer will not be sent the start command 617 that results from depression of the start key performed at the image forming apparatus 100. As a result, if, in a case where a function in which an image forming apparatus and a personal computer operate in concert is executed, as in advanced copy, there is a discrepancy in the settings for implementing this function between the image forming apparatus and the personal computer, the problem can be displayed before the function is started. This means that it is possible to eliminate the problem described earlier, namely a delay in clarification of a mismatch in the event that a mismatch occurs between the status of the image forming apparatus and the setting details of the advanced copy function received from the personal computer 170.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-131506, filed Jun. 8, 2010, which is hereby incorporated by reference herein in its entirety.

What is claimed is:

1. An image forming apparatus capable of communicating with an information processing apparatus, comprising:
a first receiving unit configured to receive identification information from the information processing apparatus, which has generated settings relating to a copy job to be executed in the image forming apparatus, the identification information indicating the settings of the copy job;
a first display unit configured to display multiple items of identification information received by the first receiving unit;
a notification unit configured to notify the information processing apparatus of identification information selected by a user from among the multiple items of identification information displayed by the first display unit;
a second receiving unit configured to receive setting values of the copy job corresponding to the selected identification information, the setting values being transmitted from the information processing apparatus in response to the notification made by the notification unit;
a determination unit configured to determine whether or not the image forming apparatus is capable of executing the copy job based upon the setting values received by the second receiving unit; and
an output unit configured to output a result of the determination made by the determination unit.

2. The apparatus according to claim 1, wherein the determination unit determines whether the copy job is capable of being executed based upon whether size of paper that has been placed in the image forming apparatus and a paper size indicated by a setting value received by the second receiving unit coincide.

3. The apparatus according to claim 1, wherein the copy job is one in which a document is read and image data generated by the image forming apparatus, the image data is transmitted to the information processing apparatus and is processed by the information processing apparatus, and an image is formed by the image forming apparatus based upon the processed image data.

4. The apparatus according to claim 1, further comprising a second display unit configured to display a plurality of information processing apparatuses capable of communicating;
wherein the first display unit displays multiple items of identification information received from an information processing apparatus selected from the plurality of information processing apparatuses displayed by the second display unit.

5. The apparatus according to claim 1, wherein identification information indicating a setting of the copy job includes the name of the setting of the copy job.

6. A method of controlling an image forming apparatus capable of communicating with an information processing apparatus, the method comprising:
a first receiving step of receiving identification information from the information processing apparatus, which has generated settings relating to a copy job to be executed in the image forming apparatus, the identification information indicating the settings of the copy job;
a first display step of displaying multiple items of identification information received in the first receiving step;
a notification step of notifying the information processing apparatus of identification information selected by a user from among the multiple items of identification information displayed in the first display step;
a second receiving step of receiving setting values of the copy job corresponding to the selected identification information, the setting values being transmitted from the information processing apparatus in response to the notification made in the notification step;
a determination step of determining whether or not the image forming apparatus is capable of executing the copy job based upon the setting values received in the second receiving step; and
an output step of outputting a result of the determination made in the determination step.
